(19) United States
(12) Patent Application Publication
(10) Pub. No.: US 2012/0218175 A1
(43) Pub. Date: Aug. 30, 2012

(54) IMAGE DISPLAY APPARATUS AND CONTROL METHOD THEREFOR

(75) Inventors: Kiyohiro Uemura, Tokyo (JP); Teruki Kikkawa, Yokohama-shi (JP)

(73) Assignee: CANON KABUSHIKI KAISHA, Tokyo (JP)

(21) Appl. No.: 13/397,181

(22) Filed: Feb. 15, 2012

(30) Foreign Application Priority Data
Feb. 28, 2011 (JP) 2011-042159
Dec. 22, 2011 (JP) 2011-281930

(51) Int. Cl. G09G 3/36

(52) U.S. Cl. 345/102

(57) ABSTRACT

An image display apparatus and a control method therefor are disclosed. The apparatus includes an obtaining unit to obtain a response start timing and a response end timing of a display panel in the case of image data to be inputted having changed, and a control unit to carry out control to turn on and off a back light based on the response start timing and the response end timing of the display panel obtained by the obtaining unit in cases where the inputted image data has changes, wherein the control unit changes the timing of turning on and off of the back light in accordance with a response time which is an interval of time from the response start timing of the display panel to the response end timing thereof.

### BACKGROUND OF THE INVENTION

1. Field of the Invention

The present invention relates to an image display apparatus and a control method therefor.

2. Description of the Related Art

In the past, image display apparatuses have a problem called a blurring of moving images in which visual artifacts or residual images are seen at the time of displaying the moving images, resulting from the fact that a liquid crystal panel is of hold type driving or the response time of a liquid crystal panel is slow. As a technique of reducing the residual images of the liquid crystal display, there is a technique called black insertion in which a black display is inserted in between image displays. In addition, there is also a technique called back light blinking which controls the turning on and off of a backlight in synchronization with the change over of images on a liquid crystal panel.

In relation to the black insertion technique, there is disclosed in Japanese patent application laid-open No. 2003-295156 an invention in which the temperature of a liquid crystal panel is measured by means of a temperature sensor, and the higher the temperature of the liquid crystal panel thus measured, the comparatively higher a proportion of a black image display period (black insertion rate) occupied in a one-frame period is made.

### SUMMARY OF THE INVENTION

The response characteristic of a liquid crystal panel changes with a change in the temperature of the panel due to an environmental change, a time degradation or aging due to the long-term use thereof, etc. When the response characteristic of the liquid crystal panel changes, the response characteristic of the transmissivity of the liquid crystal to a change in an electrical signal applied to liquid crystal elements will change. FIG. 9 is a view showing the way in which the response characteristic of a liquid crystal panel of an IPS (InPlane Switching) type changes in accordance with the temperature thereof. FIG. 9 shows changes in the luminance value of the liquid crystal panel in cases where an image displayed on the liquid crystal panel changes from a black image to a white image, in terms of two kinds of panel temperatures (30 degrees C. and 10 degrees C.), respectively. (A) in FIG. 9 shows the change of an image signal, (B) in FIG. 9 shows the change in the luminance value of the liquid crystal panel in cases where the temperature of the panel (hereinafter also referred to as a panel temperature) is 30 degrees C., and (C) in FIG. 9 shows the change in the luminance value of the liquid crystal panel in cases where the panel temperature is 10 degrees C.

In FIG. 9, a common axis of abscissa represents time; t1 indicates a change-over timing of the image; t2 and t3 indicate a rise start time and a rise end time, respectively, of the liquid crystal (hereinafter referred to as a liquid crystal rise start time and a liquid crystal rise end time, respectively) in cases where the panel temperature is 30 degrees C.; and t2′ and t3′ indicate a rise start time and a rise end time, respectively, of the liquid crystal in cases where the panel temperature is 10 degrees C. The liquid crystal rise start time is a timing at which the luminance value of the liquid crystal panel at the time of changing over from a black image display to a white image display exceeds a liquid crystal rise start threshold value. The liquid crystal rise end time is a timing at which the luminance value of the liquid crystal panel at the time of changing over from a black image display to a white image display exceeds a liquid crystal rise end threshold value. In addition, a period of time from the liquid crystal rise start time to the liquid crystal rise end time is made a response time of the liquid crystal (hereinafter also referred to as a liquid crystal response time).

In the example shown in FIG. 9, the liquid crystal rise start time t2′ in the case of the panel temperature being 10 degrees C. is later than the liquid crystal rise start time t2 in the case of the panel temperature being 30 degrees C. In addition, a response time Δt′(=t3′−t2′) of the liquid crystal in the case of the panel temperature being 10 degrees C. is longer than a response time Δt (=t3−t2) of the liquid crystal in the case of the panel temperature being 30 degrees C.

In order to reduce the blurring of moving images in an effective manner by back light blinking, it is important that the response of the liquid crystal panel to the change over of the image signal and the control of the turning on and off of the back light are carried out in synchronization with each other in an accurate manner. However, when the response characteristic of the liquid crystal panel changes due to the temperature change, the time degradation, etc., of the liquid crystal panel, as mentioned above, there will be a possibility that the response of the liquid crystal panel and the control of the turning on and off of the back light may not be accurately synchronized with each other, thus making it impossible to reduce the blurring of moving images in an effective manner.

Accordingly, the present invention provides an image display apparatus and a control method therefor in which a blurring of moving images can be reduced in a suitable manner, even in cases where the response characteristic of a display panel has changed due to a temperature change or time degradation (aging) of the display panel.

A first aspect of the present invention resides in an image display apparatus which comprises:

a back light;

a display panel that displays an image based on image data which is inputted thereto, by changing a transmissivity of light from said back light in accordance with said inputted image data;

an obtaining unit for obtaining a response start timing and a response end timing of said display panel in the case of said inputted image data having changed; and

a control unit for carrying out control to turn on and off said back light based on the response start timing and the response end timing of said display panel obtained by said obtaining unit, in cases where said inputted image data has changed;

wherein said control unit changes the timing of turning on and off of said back light in accordance with a response time which is an interval of time from the response start timing of said display panel to the response end timing thereof.

A second aspect of the present invention resides in a control method for an image display apparatus which has a back light, and a display panel that displays an image based on image data which is inputted thereto, by changing a transmissivity of light from said back light in accordance with said inputted image data, said method comprising:

an obtaining step of obtaining a response start timing and a response end timing of said display panel in the case of said inputted image data having changed; and

a control step of carrying out control to turn on and off said back light based on the response start timing and the response end timing of said display panel obtained in said obtaining step, in cases where said inputted image data has changed;

wherein in said control step, the timing of turning on and off of said back light is changed in accordance with a response time which is an interval of time from the response start timing of said display panel to the response end timing thereof.

According to the present invention, it is possible to provide an image display apparatus and a control method therefor in which a blurring of moving images can be reduced in a suitable manner, even in cases where the response characteristic of a display panel has changed due to a temperature change or time degradation of the display panel.

Further features of the present invention will become apparent from the following description of exemplary embodiments with reference to the attached drawings.

### BRIEF DESCRIPTION OF THE DRAWINGS

FIG. 1 is a block diagram showing the construction of an image display apparatus in a first embodiment of the present invention.

FIG. 2 is a flow chart showing an operation of an image display apparatus in the first embodiment and a second embodiment of the present invention.

FIG. 3 is a flow chart of calibration in the first and second embodiments and in a third embodiment of the present invention.

FIG. 4 is a flow chart for the determination of a response time in the first and third embodiments.

FIG. 5 is a block diagram showing the construction of an image display apparatus in the second embodiment.

FIG. 6 is a flow chart for the determination of a response time in the second embodiment.

FIG. 7 is a block diagram showing the construction of an image display apparatus in the third embodiment.

FIG. 8 is a flow chart showing an operation of the image display apparatus in the third embodiment.

FIG. 9 shows an example of a change of a response time due to an environmental change.

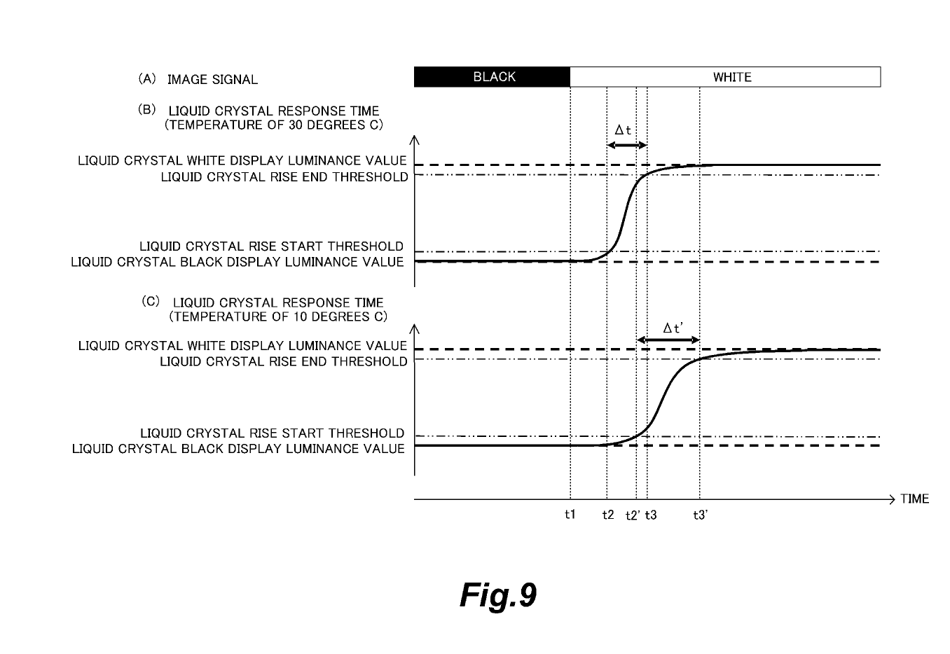

FIG. 10 shows an example for a response time of a liquid crystal and a change in lighting control of a back light.

### DESCRIPTION OF THE EMBODIMENTS

### First Embodiment

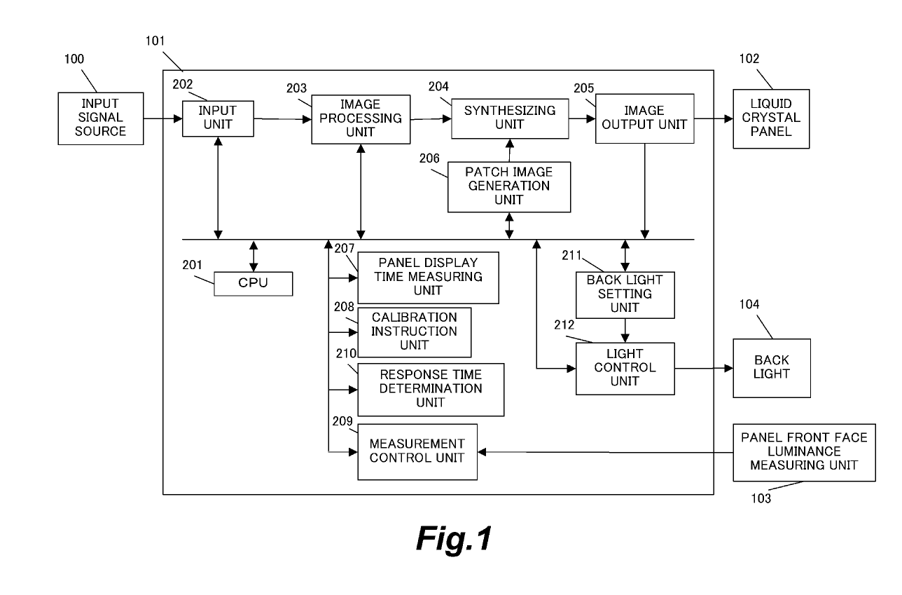

A first embodiment of the present invention will be described below. FIG. 1 is a schematic view of a system construction of an image display apparatus to which the present invention is applied. An input signal source 100 is a device that outputs an image signal, such as a broadcast receiving device, a playback system such as a DVD player, a picture recording system, a personal computer, etc.

A display control device 101 includes an input unit 202 from which an image signal outputted from the input signal source 100 is inputted, and an image output unit 205 from which an image signal is outputted to a liquid crystal panel 102. In addition, the display control device 101 also includes a measurement control unit 209 from which measured luminance information outputted by a panel front face luminance measuring unit 103 is inputted, and a light control unit 212 from which a drive control signal is outputted to a back light 104.

The liquid crystal panel 102 has a plurality of pixels arranged in a matrix form in a predetermined viewing area, and displays an image by changing the transmissivity of light from the back light 104 in accordance with the image signal inputted from the display control device 101. Here, note that the present invention can be applied to any display panel or the like, even if it is not a liquid crystal panel, but as long as it is a hold type drive display panel of a shutter system which requires a back light, and of which the response time is long to some extent. The panel front face luminance measuring unit 103 measures the luminance of a predetermined area to be measured in a display area (e.g., a central portion of the display area, or a central portion of an upper end of the display area) of the liquid crystal panel 102, and outputs the measurement result to the measurement control unit 209 as measured luminance information. The panel front face luminance measuring unit 103 is a luminance sensor, for example, and may be fixedly secured to the central portion of the upper end of the display area of the liquid crystal panel 102. Alternatively, the panel front face luminance measuring unit 103 may be constructed such that it is recessed in the inside of a cover which serves to cover the peripheral portions of the liquid crystal panel 102, and can be pulled out into the central portion of the display area only when necessary.

The back light 104 has one or a plurality of light sources which illuminate the liquid crystal panel 102, and the turning on and off of the light source(s) is controlled in accordance with the drive control signal inputted thereto from the display control device 101. As the light source, there can be mentioned, as some examples, a CCFL (cold cathode fluorescent lamp), an RGB-LED (light-emitting diode), a white LED, etc., and any of a light guiding type and a direct-underneath type may be available as such. In addition, the back light 104 may also be constructed such that it is divided into a plurality of blocks, and it is able to be controlled in a local dimming manner so that the lighted state (emission intensity) of a light source for each block is independently controlled on a block by block basis.

In the image display apparatus of this embodiment, in cases where the image signal inputted to the liquid crystal panel 102 has changed, back light control (back light blinking) is carried out in such a manner that the back light 104 is caused to turn on and off based on the response characteristic of the liquid crystal panel 102. More specifically, the back light 104 is caused to be lit on or off (turned on or off) in synchronization with the liquid crystal rise start time (response start timing) and the liquid crystal rise end time (response end timing) of the luminance of the liquid crystal panel at the time of the change over of the image signal. That is, the back light 104 is caused to be lit off (turned off) in the response time which is an interval of time from the liquid crystal rise start time to the liquid crystal rise end time (i.e., an interval of time from the response start timing to the response end timing).

A method of synchronizing the back light blinking of the back light 104 with the response of the liquid crystal will be described later. By means of the back light blinking, a pseudo impulse display will be carried out, so that the blurring of moving images can be reduced. Here, note that in order to reduce the blurring of moving images in a more effective manner, black insertion may be carried out in which a black image display is carried out in a part of the display period of one frame of the image signal. Black insertion may be carried out according to a method of forming a part of one frame into a strip or band-shaped black image, and then moving the position of the band-shaped black image within the display period of the one frame. In the back light blinking, a part of the back light corresponding in position to the display area of the black image may be lit off (tuned off).

The display control device 101 is provided with a CPU 201, the input unit 202, an image processing unit 203, a synthesizing unit 204, the image output unit 205, a patch image generation unit 206, and a panel display time measuring unit 207. The display control device 101 is further provided with a calibration instruction unit 208, the measurement control unit 209, a response time determination unit 210, a back light setting unit 211, and the light control unit 212.

The CPU 201 controls the overall operation of the display control device 101. A ROM (read-only memory), a RAM (random access memory) and a timer, which are not illustrated, are connected to the CPU 201. The CPU 201 executes programs stored in the ROM, uses the RAM as a work memory, and carries out time management by the use of the timer.

The input unit 202 decodes an image signal inputted thereto from the input signal source 100, and outputs image data to the image processing unit 203. The image processing unit 203 applies image processing such as high definition processing to the image data inputted from the input unit 202, and thereafter outputs the image data thus processed to the synthesizing unit 204.

The synthesizing unit 204 serves to superimpose image data of a patch image inputted from the patch image generation unit 206, which will be described later, on the image data inputted from the image processing unit 203, and outputs it to the image output unit 205. The image output unit 205 outputs the image data inputted from the synthesizing unit 204 to the liquid crystal panel 102, and at the same time, outputs a vertical synchronizing signal to the light control unit 212 and the response time determination unit 210.

The patch image generation unit 206 generates the image data of the patch image based on patch information which is inputted from the response time determination unit 210 to be described later, and outputs it to the synthesizing unit 204, and at the same time, outputs a patch output timing signal to the response time determination unit 210. Here, the patch information is information which specifies the color, size, display position and the like, of a patch image to be generated. The patch output timing signal is a signal which is in synchronization with an output of patch image data to the synthesizing unit 204.

The panel display time measuring unit 207 measures an elapsed period of time (a panel display period of time) after the liquid crystal panel 102 starts to display an image, by the use of the timer with which the CPU 201 is provided, and outputs it to the calibration instruction unit 208 as panel display time information. For example, the panel display time measuring unit 207 starts the measurement of the period of time by setting to zero the point in time at which the image output unit 205 starts to output image data to the liquid crystal panel 102.

The calibration instruction unit 208 obtains the panel display period of time from the panel display time information which is inputted from the panel display time measuring unit 207. In cases where a determination has been made that the panel display period of time has increased by a predetermined period of time, the calibration instruction unit 208 gives to the response time determination unit 210 an instruction to change (calibrate) the timing of lighting on and off (turning on and off) of the back light. This predetermined period of time is decided from a panel display period of time within which the temperature of the liquid crystal panel 102 does not change to a large extent, and it is decided by measurements and held in the ROM beforehand.

Based on the measured luminance information inputted from the panel front face luminance measuring unit 103, the measurement control unit 209 measures the luminance of the area to be measured of the liquid crystal panel 102, and outputs the luminance value thus obtained to the response time determination unit 210. When a calibration instruction of the lighting (turn on) timing of the back light is received from the calibration instruction unit 208, the response time determination unit 210 outputs back light driving control information for measurement to the back light setting unit 211, which will be described in detail later, and at the same time, outputs patch information to the patch image generation unit 206.

Here, the back light driving control information for measurement is back light driving control information which is applied to driving control of the back light corresponding in position to the area to be measured of the liquid crystal panel 102. The back light driving control information is setting information on the turn on and off control of the back light, and includes blinking start time information and blinking period of time information. Here, the blinking start time represents a period of time for which the light control unit 212 delays the start timing of the back light blinking driving control with respect to the vertical synchronizing signal, as will be described in detail later.

The blinking period of time information represents a turn on period of time and a turn off period of time of the back light 104 in the back light blinking driving control. In the back light driving control information for measurement, the blinking start time is zero, and the turn off period of time in the blinking period of time information is zero. That is, at the time when the luminance value of the area to be measured of the liquid crystal panel 102 is measured for the calibration of the turn on timing of the back light, the back light corresponding in position to the area to be measured is constantly turned on.

In addition, the response time determination unit 210 generates response time information based on the patch output timing signal inputted from the patch image generation unit 206, the vertical synchronizing signal inputted from the image output unit 205, and the luminance value inputted from the measurement control unit 209. Here, the response time information is information with respect to the response time of the liquid crystal (information on the liquid crystal rise start time and the liquid crystal rise end time). The details of a method of generation of the response time information will be described later. The response time determination unit 210 outputs the response time information to the back light setting unit 211.

The back light setting unit 211 converts the back light driving control information inputted from the response time determination unit 210 into back light driving control data, and outputs it to the light control unit 212. Here, the back light driving control data is control data which is used in order for the light control unit 212 to drive the back light 104. In cases where a power supply for the image display apparatus is switched on, the back light setting unit 211 reads out the back light driving control information, which has been default or initially set, from the ROM, converts the default or initially set back light driving control information thus read out into back light driving control data, and outputs it to the light control unit 212.

Moreover, in calibrating the turn on timing of the back light, the back light setting unit 211 modifies or edits the back light driving control information based on the response time information inputted from the response time determination unit 210. Then, the back light setting unit 211 converts the thus modified back light driving control information into backlight driving control data, and outputs it to the light control unit 212, and at the same time, saves or stores the thus modified back light driving control information into the ROM.

The light control unit 212 carries out the back light blinking driving control based on the back light driving control data set by the back light setting unit 211 in synchronization with the vertical synchronizing signal inputted from the image output unit 205. In the back light blinking of this embodiment, at a point in time in which the blinking start time has elapsed from the vertical synchronizing signal, the back light 104 is caused to turn off, and then, at a point in time in which the turn off period of time specified in the blinking period of time information has elapsed from the first mentioned point in time, the back light 104 is caused to turn on.

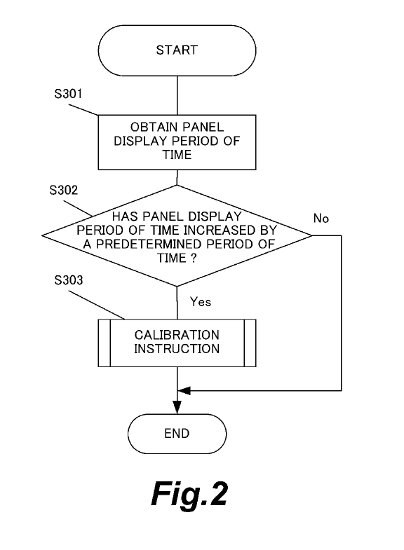

Next, reference will be made to the operation of the display control device 101 by the use of a flow chart shown in FIG. 2. When a user performs a power turn-on operation of the image display apparatus, the processing of this flow chart by means of the CPU 201 is started. The panel display time measuring unit 207 measures a panel display period of time, and outputs panel display time information thus obtained to the calibration instruction unit 208 (step S301).

The calibration instruction unit 208 determines, based on the panel display time information obtained from the panel display time measuring unit 207, whether the panel display period of time has increased by a predetermined period of time (step S302). In cases where the panel display period of time has not yet increased by the predetermined period of time, the processing of this flow chart is ended. On the other hand, in cases where the panel display period of time has increased by the predetermined period of time, the calibration instruction unit 208 gives to the response time determination unit 210 an instruction to calibrate the turn on timing of the back light (step S303). For example, in cases where a threshold value is set to be 10 seconds, each time the panel display period of time passes 10 seconds, the calibration instruction unit 208 gives an instruction to calibrate the turn on timing of the back light to the response time determination unit 210.

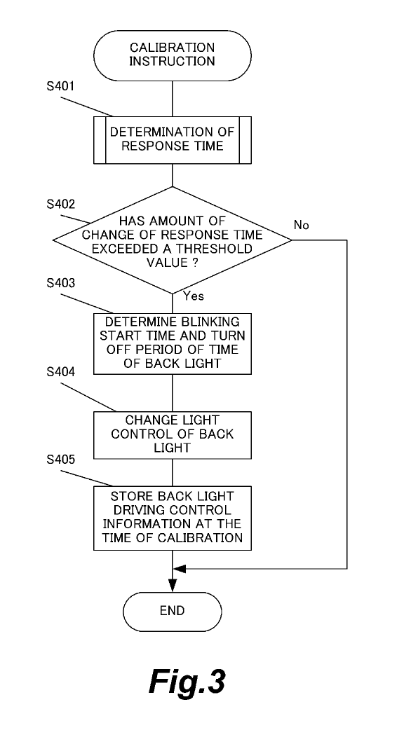

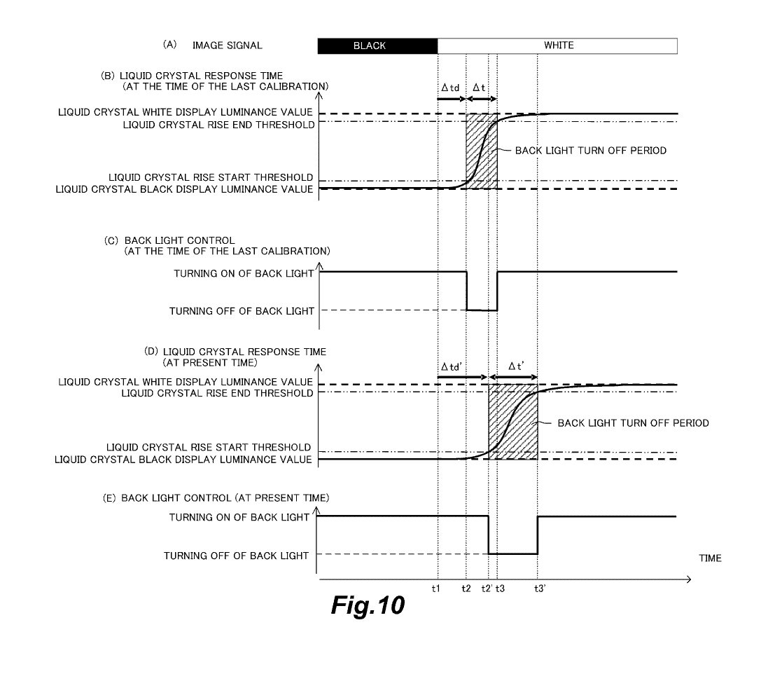

Next, the details of the calibration in the back light driving control will be described based on a flow chart shown in FIG. 3 and a timing chart of FIG. 10. FIG. 3 is the flow chart showing the procedure of the calibration of the turn on timing of the back light. FIG. 10 shows changes in the luminance value of the liquid crystal panel and changes in the turn on and off of the back light, in cases where an image displayed on the liquid crystal panel 102 changes from a black patch image to a white patch image.

(A) in FIG. 10 shows an image signal. (B) in FIG. 10 shows the change of the luminance value of the liquid crystal panel in the last calibration, and (C) in FIG. 10 shows the change of the state of the turning on and off of the back light 104 based on the back light driving control information which has been decided by the last calibration. (D) in FIG. 10 shows the current (present) change of the luminance value of the liquid crystal panel, and (E) in FIG. 10 shows the change of the state of the turning on and off of the back light 104 based on the back light driving control information which has been decided by the present calibration.

In FIG. 10, the common axis of abscissa represents time, and t1 is timing at which the black patch image is changed over to the white patch image, that is, it is the timing of the vertical synchronizing signal which is outputted at the time when the white patch image is displayed on the liquid crystal panel 102. t2 and t3 indicate a liquid crystal rise start time and a liquid crystal rise end time in the last calibration, respectively, and t2′ and t3′ indicate a current (present) liquid crystal rise start time and a current (present) liquid crystal rise end time, respectively.

As shown in FIG. 10, in comparison with the time in which the last calibration was carried out, the response characteristic of the liquid crystal panel has changed at the present time, so that the liquid crystal rise start time becomes slower, and the response time becomes longer. This is due to a difference in the temperature of the liquid crystal panel or a difference in the environmental temperature between the last calibration execution time and the present time. When the back light blinking is carried out based on the back light driving control information decided by the last calibration, the period of time in which the back light 104 is caused to turn off will become a period of time from t2 to t3, but the present response time of the liquid crystal panel is a period of time from t2′ to t3′.

For that reason, when the back light blinking based on the back light driving control information decided by the last calibration is carried out in the present operating environment, the turn off period of time of the back light 104 and the response time of the liquid crystal panel do not match with each other. Accordingly, by changing or modifying the turn on timing of the back light according to the present response characteristic of the liquid crystal panel, the back light driving control information is changed or modified so that the turn off period of time of the back light 104 and the present response time of the liquid crystal panel are in match with each other, as shown in (E) of FIG. 10. In the following, the details of the calibration of the turn on timing of the back light will be described.

When the calibration instruction unit 208 gives the instruction to calibrate the turn on timing of the back light to the response time determination unit 210, the response time determination unit 210 determines, in step S401, the present response time (Δt′) of the liquid crystal panel 102. The details of a method of determination of the response time will be described later.

In step S402, the response time determination unit 210 reads in the response time (Δt) of the liquid crystal panel 102 in the last calibration which was saved or stored in the ROM in the last calibration, and compares it with the present response time (Δt′) of the liquid crystal panel 102 which has been determined in step S401. The response time determination unit 210 calculates a difference between the response time Δt in the last calibration, and the present response time Δt′ (i.e., an amount of change of the response time) (=|Δt′−Δt|), and determines whether the amount of change of the response time exceeds a threshold value.

This threshold value is decided by an amount of change of the response time at which the extent or degree of the blurring of moving images generated by a deviation in synchronism between the response time of the liquid crystal and the back light blinking resulting from a change in the response characteristic of the liquid crystal panel 102 exceeds an acceptable level which has been decided beforehand. The threshold value has been beforehand held in the ROM. Here, the threshold value for the amount of change of the response time is set to 5 ms. In cases where the amount of change of the response time does not exceed the threshold value, the processing of this flow chart is ended. On the other hand, in cases where the amount of change of the response time exceeds the threshold value, the processing of the response time determination unit 210 goes to processing in step S403.

In step S403, the response time determination unit 210 updates the response time information, which has been saved in the last calibration, with the use of the present response time information which has been determined in step S401. The response time determination unit 210 outputs the thus updated response time information to the back light setting unit 211. The back light setting unit 211 calculates an interval of time Δtd′(=t2′−t1) of the present liquid crystal rise start time t2′ and the timing t1 of the vertical synchronizing signal based on the updated response time information, and updates the blinking start time by the use of the interval of time thus obtained. In addition, the back light setting unit 211 updates the turn off period of time in the blinking period of time information by the use of the present response time Δt′.

In step S404, the back light setting unit 211 updates the back light driving control information decided in the last calibration by the use of the updated blinking start time and the updated turn off period of time. The back light setting unit 211 converts the thus updated back light driving control information into back light driving control data, and outputs it to the light control unit 212. The light control unit 212 drives the back light 104 based on the back light driving control data inputted from the back light setting unit 211.

That is, the light control unit 212 drives the back light 104 to be turned off at timing t2′, which is delayed by the updated blinking start time Δtd′ with respect to the vertical synchronizing signal (t1) inputted thereto from the image output unit 205. Then, the back light 104 is turned on at timing t3′ which has passed the updated turn off period of time Δt from the timing t2′. As a result of this, the back light 104 is driven in such a manner that the state of the turning on and off of the back light 104 is changed over in synchronization with the present response time of the liquid crystal, as shown in (E) of FIG. 10.

In step S405, the response time determination unit 210 stores the back light driving control information, which has been changed or modified by the calibration, into the ROM. In this manner, the timing of turning on and off of the back light 104 is changed according to the present liquid crystal rise start time and the present liquid crystal rise end time of the liquid crystal panel.

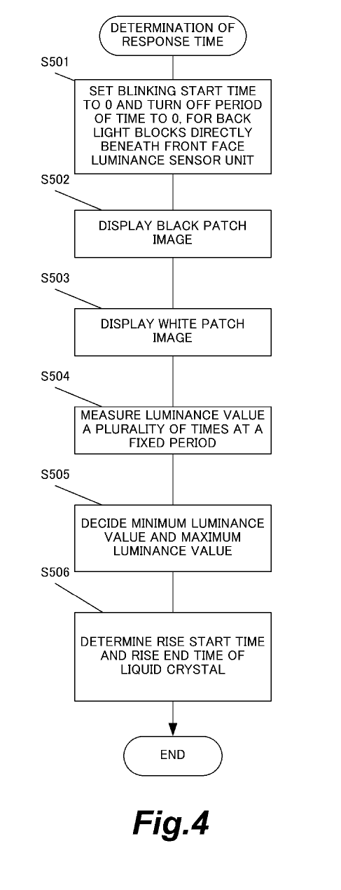

Next, reference will be made to the details of the method of determination of the response time by the use of a flow chart shown in FIG. 4. When determination processing of the response time starts, the response time determination unit 210 sets the back light setting unit 211 in such a manner that driving control of the backlight corresponding to the area to be measured is carried out based on the back light driving control information for measurement (step S501). The back light driving control information for measurement is back light driving control information in which the blinking start time is zero and the turn off period of time is zero. The back light 104 to which the back light driving control information for measurement is applied is constantly turned on.

In step S502, the response time determination unit 210 outputs patch information, which specifies a black image (black patch image) of such a size and position as to cover the area to be measured by the panel front face luminance measuring unit 103, to the patch image generation unit 206.

The patch image generation unit 206 generates a patch image based on the patch information which has been inputted from the response time determination unit 210, and outputs it to the synthesizing unit 204, and at the same time, outputs a patch output timing signal to the response time determination unit 210. This patch output timing signal becomes a first patch output timing signal in the determination processing of the response time.

The synthesizing unit 204 serves to superimpose the image data of the black patch image inputted from the patch image generation unit 206 on the image data inputted from the image processing unit 203, and outputs synthesized image data thus obtained to the image output unit 205. The image output unit 205 outputs the synthesized image data to the liquid crystal panel 102, and at the same time, outputs a vertical synchronizing signal to the response time determination unit 210.

In step S503, the response time determination unit 210 outputs patch information, which specifies a white image (white patch image) of such a size and position as to cover the area to be measured, to the patch image generation unit 206, after a fixed period of time has elapsed from a point in time at which the first patch output timing signal was inputted thereto. Here, the fixed period of time is a period of time from a point in time at which the black patch image was displayed on the liquid crystal panel 102 until the response of the liquid crystal panel becomes stable, and it may be set to 100 ms, for example.

The patch image generation unit 206 generates a patch image based on the patch information which has been inputted from the response time determination unit 210, and outputs it to the synthesizing unit 204, and at the same time, outputs a patch output timing signal to the response time determination unit 210. This patch output timing signal becomes a second patch output timing signal in the determination processing of the response time.

The synthesizing unit 204 serves to superimpose the image data of the white patch image inputted from the patch image generation unit 206 on the image data inputted from the image processing unit 203, and outputs synthesized image data thus obtained to the image output unit 205. The image output unit 205 outputs the synthesized image data to the liquid crystal panel 102, and at the same time, outputs a vertical synchronizing signal to the response time determination unit 210.

When receiving the vertical synchronizing signal immediately after reception of the second patch output timing signal, the response time determination unit 210 obtains from the measurement control unit 209 luminance values a fixed number of times at a fixed period (e.g., 50 times at a period of 1 ms) (step S504). The response time determination unit 210 decides a minimum luminance value Lum_min and a maximum luminance value Lum_max from a fixed number of luminance values Lum(t) obtained from the measurement control unit 209 (step S505). Here, a luminance value Lum(t) represents a luminance value which the response time determination unit 210 obtained from the measurement control unit 209 at a point in time t.

In step S506, the response time determination unit 210 calculates a rise start time t_rise_start of the liquid crystal, and a rise end time t_rise_end of the liquid crystal as timings which satisfy the following relational expressions.

Lum(t_rise_start)=(Lum_max_{—}Lum_min)×th_rise_start+Lum_min

Lum(t_rise_end)=(Lum_max−Lum_min)×th_rise_end +Lum_min (Equation 1)

Here, a rise start threshold value th_rise_start and a rise end threshold value th_rise_end are fixed values, respectively, wherein for example, the rise start threshold value is set to 0.1 (th_rise_start=0.1), and the rise end threshold value is set to 0.9 (th_rise_end=0.9). The rise start threshold value and the rise end threshold value are decided from the general response characteristic of the liquid crystal panel 102. The response time determination unit 210 determines that the liquid crystal rise start time t_rise_start and the liquid crystal rise end time t_rise_end, which have been calculated from the above-mentioned expressions, are the present liquid crystal rise start time t2′ and the present liquid crystal rise end time t3′. Here, note that it is preferable that the black patch image and the white patch image be displayed to be small at an end of the liquid crystal panel. For example, the black patch image and the white patch image may be displayed to be small in the display area of the liquid crystal panel 102 at positions in opposition to the panel front face luminance measuring unit 103 which is arranged in the central portion of the upper end of the display area. When the black patch image and the white patch image are displayed to be small at one end of the liquid crystal panel in this manner, it is possible for the user to display a desired image in other portions of the display area of the liquid crystal panel, so user's work or operation does not have to be disturbed or interrupted. In addition, the determination processing of the response time in FIG. 4 may be carried out at a time in which the display control device 101 is not used. For example, if the display control device 101 is in use at the time when a calibration instruction in step S303 of FIG. 2 is issued, the processes of FIGS. 3 and 4 are once suspended, and then, after the use of the display control device 101 has been finished (i.e., after an operation of turning off the power supply has been done), the processes of FIGS. 3 and 4 maybe carried out. Moreover, in this embodiment, reference has been made to an example in which a white patch image is displayed after a black patch image has been displayed, but the response time of the liquid crystal panel may be determined by displaying a black patch image after a white patch image has been displayed. Further, the response time of the liquid crystal panel may be determined by displaying a gray (ash color) patch image after a black patch image has been displayed, or displaying a black patch image after a gray (ash color) patch image has been displayed. Alternatively, the response time of the liquid crystal panel may be determined by displaying a white patch image after a gray (ash color) patch image has been displayed, or displaying a gray (ash color) patch image after a white patch image has been displayed. Furthermore, the response time of the liquid crystal panel maybe determined by displaying a light gray (light ash color) patch image after a dark gray (dark ash color) patch image has been displayed, or displaying a dark gray (dark ash color) patch image after a light gray (light ash color) patch image has been displayed.

In this embodiment, in cases where the response time of the liquid crystal panel has a change exceeding the threshold value from the last calibration, the back light driving control information is changed in accordance with the present response characteristic of the liquid crystal panel. As a result of this, even in cases where the response characteristic of the liquid crystal panel has changed, it is possible to make the turn off period of time by the back light blinking in synchronization with the response time of the liquid crystal panel with a high degree of accuracy, so it becomes possible to reduce the blurring of moving images in a suitable manner.

Here, note that although in this embodiment, image data outputted from the image processing unit 203 and the image data of a patch image are synthesized with each other, it may be constructed such that image data before inputted to the image processing unit 203 and the image data of a patch image may be synthesized with each other.

In this embodiment, reference has been made to an example in which the present response time of the liquid crystal is determined based on Equation 1 above, while using the rise start threshold value and the rise end threshold value which are fixed values, respectively, and the turn on timing of the back light is calibrated so as to match with the response time thus determined. However, the calibration method for the turn on timing of the back light is not limited to this. For example, it may be possible to set, as the turn off period of time, a period of time which is calculated so as to suppress the occurrence of flicker resulting from the back light blinking, with respect to a period of time in which the blurring of moving images is the most remarkable.

In addition, in cases where the turn off period of time of the back light blinking has been changed by calibration, the luminance of display may be changed, and hence, it is also suitable to make the luminance of display become fixed by changing the value of electric current of the back light according to the change of the turn off period of time, etc.

### Second Embodiment

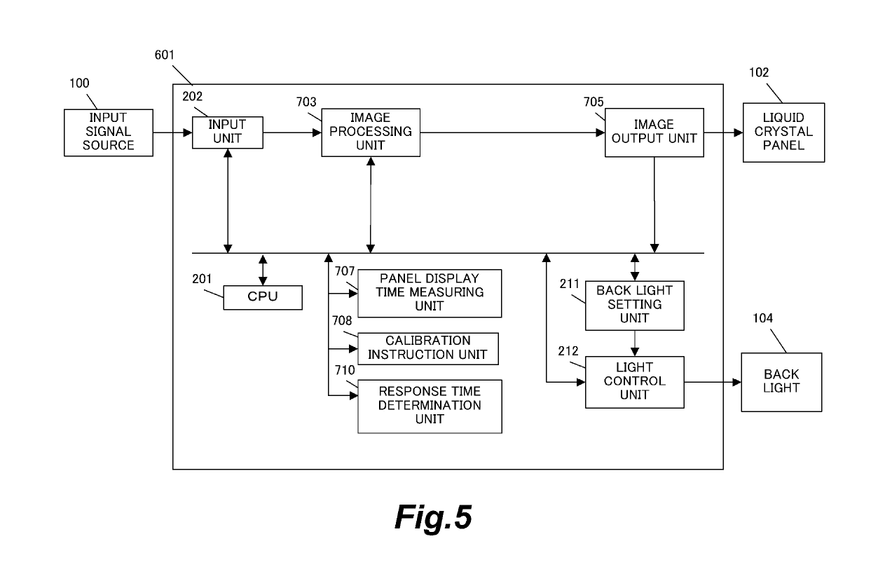

A second embodiment of the present invention will be described below. FIG. 5 is a schematic view of a system construction of an image display apparatus to which the present invention is applied. Hereinafter, an explanation about the second embodiment will be made by focusing on differences with respect to the first embodiment. Main differences between the second embodiment and the first embodiment are the timing (condition) in which calibration of the turn on timing of the back light is carried out, and the determination method for the present response time of the liquid crystal panel.

In the first embodiment, calibration is carried out at the time when the time elapsed after an image starts to be displayed on the liquid crystal panel 102 exceeds the threshold value, but in the second embodiment, calibration is carried out each time the display period of time (accumulated display period of time) of the liquid crystal panel 102 integrated from the time of factory shipment passes one of a plurality of threshold values which are set in a stepwise manner. The accumulated display period of time may be measured from a point in time at which the image display apparatus was powered on for the first time.

In addition, in the first embodiment, the present response time of the liquid crystal panel 102 is determined from the measured value of the actual luminance value at the time when an image for measurement is displayed on the liquid crystal panel, but in the second embodiment, the present response time of the liquid crystal panel 102 is estimated from the accumulated display period of time thereof. The feature of changing or modifying the timing of turning on and off of the back light according to the present response time of the liquid crystal panel 102 thus estimated is the same as that of the first embodiment.

A display control device 601 includes an input unit 202 from which an image signal outputted from an input signal source 100 is inputted, and an image output unit 705 from which an image signal is outputted to the liquid crystal panel 102. In addition, the display control device 601 outputs a drive control signal from a light control unit 212 to a back light 104, thereby driving the backlight 104. The display control device 601 is provided with a CPU 201, the input unit 202, an image processing unit 703, the image output unit 705, a panel display time measuring unit 707, a calibration instruction unit 708, a response time determination unit 710, a back light setting unit 211, and the light control unit 212.

The image processing unit 703 applies image processing such as high definition processing to the image data inputted from the input unit 202, and thereafter outputs the image data thus processed to the image output unit 705. The image output unit 705 outputs the image data inputted from the image processing unit 703 to the liquid crystal panel 102, and at the same time, outputs a vertical synchronizing signal to the light control unit 212.

By using a timer provided by the CPU 201 and the accumulated display period of time stored in the ROM, the panel display time measuring unit 707 measures the accumulated display period of time from the time of shipment of the image display apparatus up to the present time, and outputs it to the calibration instruction unit 708 as the panel display time information. The accumulated display period of time is calculated by accumulating or integrating the period of time in which images are displayed on the liquid crystal panel 102 from a point in time at which the power was turned on for the first time (i.e., at a point in time at which the liquid crystal panel 102 displayed an image for the first time, or at the time of shipment from a factory).

For example, when a power supply for the image display apparatus is turned on, the panel display time measuring unit 707 reads out from the ROM the accumulated display period of time up to that point in time, and at the same time, starts to count the image display period of time of the liquid crystal panel 102 from the turning on of the apparatus, i.e., an increment of the accumulated display period of time, by the use of the timer. Then, at the time when the power supply for the image display apparatus is caused to turn off, the panel display time measuring unit 707 obtains the accumulated display period of time up to that point in time, stores it in the ROM, and updates the existing accumulated display period of time. An initial value of the accumulated display period of time at the time of factory shipment is set to zero.

The calibration instruction unit 708 obtains the accumulated display period of time from the panel display time information which is inputted from the panel display time measuring unit 707, and determines whether the accumulated display period of time has reached a threshold value. Here, a plurality of values are set in a stepwise manner as threshold values, and after it is determined that the accumulated display period of time has reached a certain threshold value, the calibration instruction unit 708 changes an existing threshold value into a new threshold value in the following stage or step, and after that, determines whether the accumulated display period of time reaches the threshold value thus changed.

Each time the accumulated display period of time reaches one of the plurality of stepwise threshold values, the calibration instruction unit 708 gives an instruction to calibrate the turn on timing of the back light to the response time determination unit 710. Each of the threshold values is decided by an accumulated display period of time in which the extent or degree of the blurring of moving images generated by a deviation in synchronism between the response time of the liquid crystal and the back light blinking resulting from a change over time in the response characteristic of the liquid crystal panel 102 exceeds an acceptable level which has been decided beforehand. The threshold values have been beforehand held in the ROM.

For example, in cases where the threshold values are set to be 10,000 hours, 20,000 hours, 25,000 hours, 28,000 hours, and 30,000 hours, respectively, at first, when the accumulated display period of time has reached 10,000 hours, calibration of the turn on timing of the back light is carried out. Then, at a point in time when the image display period of time of the liquid crystal panel 102 increases by further 10,000 hours and the accumulated display period of time has reached 20,000 hours, calibration of the turn on timing of the back light is carried out again. Thereafter, at a point in time when the image display period of time of the liquid crystal panel 102 increases by further 5,000 hours and the accumulated display period of time has reached 25,000 hours, calibration of the turn on timing of the back light is carried out again.

The response time determination unit 710 obtains an accumulated display period of time from the panel display time information which is inputted from the panel display time measuring unit 707, and determines the response time of the liquid crystal panel according to the accumulated display period of time thus obtained, with reference to a response time estimation table which has been stored in the ROM.

Here, the response time estimation table is a table in which the accumulated display period of time is associated with the response characteristic (liquid crystal rise start time, liquid crystal rise end time, response time) of the liquid crystal panel which are estimated from the accumulated display period of time. Such a table has been beforehand prepared by measurements, and held in the ROM. The response time determination unit 710 outputs the response time of the liquid crystal panel thus determined to the back light setting unit 211 as response time information.

Next, reference will be made to the operation of the display control device 601 by the use of the flow chart shown in FIG. 2. Here, note that in this embodiment, the “panel display period of time” of FIG. 2 is read as the “accumulated display period of time”. When a user performs a power turn-on operation of the image display apparatus, the processing of this flow chart by means of the CPU 201 is started.

The panel display time measuring unit 707 measures an accumulated display period of time, and outputs it to the calibration instruction unit 708 as panel display time information (step S301). The calibration instruction unit 708 obtains the accumulated display period of time from the panel display time information obtained from the panel display time measuring unit 707, and determines whether the accumulated display period of time has reached a threshold value (step S302). In cases where the accumulated display period of time has not yet reached the threshold value, the processing of this flow chart is ended. On the other hand, in cases where the accumulated display period of time has reached the threshold value, the calibration instruction unit 708 gives to the response time determination unit 710 an instruction to calibrate the driving control of the back light (step S303).

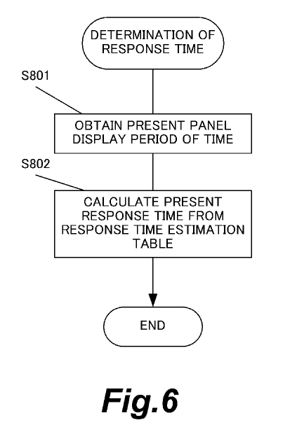

The calibration of the turn on timing of the back light is carried out according to the flow chart of FIG. 3, similar to the first embodiment. However, unlike the first embodiment, the determination processing of the response time in step S401 is carried out according to a flow chart of FIG. 6 to be described later.

Here, note that the threshold value (referred to as A) for the accumulated display period of time used in the determination in step S302 may be set to be an accumulated display period of time in which an amount of change of the response time due to the change over time of the liquid crystal panel 102 exceeds a threshold value (referred to as B) for the amount of change of the response time which is used in the determination in step S402 of the first embodiment. In this case, at a point in time at which the accumulated display period of time has exceeded the threshold value A in step S302, a determination can be made that the amount of change of the response time of the liquid crystal panel 102 has exceeded the threshold value B, and hence, in the flow chart of FIG. 3, the determination processing of step S402 may be omitted. In other words, in this case, when it is determined that the accumulated display period of time has exceeded the threshold value A, calibration is always carried out.

Next, reference will be made to the details of the determination processing of the response time by the use of the flow chart shown in FIG. 6. The response time determination unit 710 obtains an accumulated display period of time up to the present point in time from the panel display time information which is inputted from the panel display time measuring unit 707 (step S801).

With reference to the response time estimation table, the response time determination unit 710 calculates the response time of the liquid crystal panel 102 corresponding to the accumulated display period of time up to the present point in time, and outputs it to the back light setting unit 211 as response time information (step S802).

As described above, in cases where it is determined from the accumulated display period of time that the response time of the liquid crystal panel 102 has a change exceeding the threshold value, the response time determination unit 710 changes or modifies the back light driving control information in accordance with the present response characteristic of the liquid crystal panel. As a result of this, even in cases where the response characteristic of the liquid crystal panel has changed due to a long period of use, it is possible to make the turn off period of time by the back light blinking in synchronization with the response time of the liquid crystal panel with a high degree of accuracy, so it becomes possible to reduce the blurring of moving images in a suitable manner, irrespective of the period of use of the liquid crystal panel. In addition, the present response time of the liquid crystal panel is obtained by estimation based on the accumulated display period of time of the liquid crystal panel without measuring the luminance of the liquid crystal panel, so it is possible to perform the calibration with a simple construction.

Here, note that although reference has been made to an example in which a determination as to whether the execution of calibration is necessary is carried out based on a comparison between the plurality of stepwise threshold values which have been decided beforehand and the accumulated display period of time, the calibration may be made at a fixed period (e.g., every 3,000 hours).

### Third Embodiment

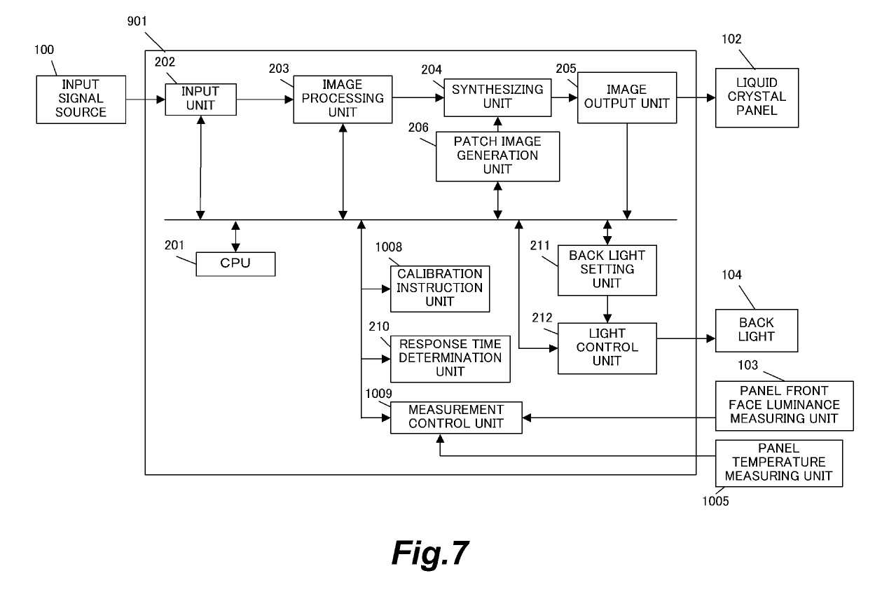

A third embodiment of the present invention will be described below. FIG. 7 is a schematic view of a system construction of an image display apparatus to which the present invention is applied. Hereinafter, an explanation about the third embodiment will be made by focusing on differences with respect to the first embodiment. A main difference between the third embodiment and the first embodiment is the timing (condition) in which the calibration of the turn on timing of the back light is carried out. In the first embodiment, the calibration is carried out in cases where a period of time elapsed after an image starts to be displayed on the liquid crystal panel 102 exceeded the threshold value, but in the third embodiment, the calibration is carried out in cases where an amount of change in the temperature of a liquid crystal panel 102 (hereinafter also referred to as a panel temperature) from a point in time at which calibration was carried out at the last time exceeds a threshold value.

A display control device 901 includes an input unit 202 from which an image signal outputted from an input signal source 100 is inputted, and an image output unit 205 from which an image signal is outputted to the liquid crystal panel 102. In addition, the display control device 901 also includes a measurement control unit 1009 from which measured luminance information outputted by a panel front face luminance measuring unit 103 is inputted, and from which temperature information outputted by a panel temperature measuring unit 1005 is also inputted. Further, the display control device 901 outputs a drive control signal from a light control unit 212 to aback light 104.

The panel temperature measuring unit 1005 measures the temperature of the liquid crystal panel 102, and outputs it to the measurement control unit 1009 as temperature information. The measurement control unit 1009 calculates the panel temperature from the temperature information inputted from the panel temperature measuring unit 1005, and outputs it to a calibration instruction unit 1008. Based on the measured luminance information inputted from the panel front face luminance measuring unit 103, the measurement control unit 1009 calculates the value of the luminance of an area to be measured of the liquid crystal panel 102, and outputs it to the response time determination unit 210.

The calibration instruction unit 1008 makes a comparison between the present panel temperature inputted from the measurement control unit 1009, and a panel temperature in the last calibration which has been stored in the ROM, and determines whether an amount of change thereof (i.e., an amount of change of the panel temperature) has exceeded a threshold value. In cases where the amount of change of the panel temperature exceeds the threshold value, the calibration instruction unit 1008 gives to the response time determination unit 210 an instruction to calibrate the turn on timing of the back light, and at the same time, stores the present panel temperature in the ROM.

Here, the threshold value for the amount of change of the panel temperature is decided by an amount of change of the panel temperature at which the extent or degree of the blurring of moving images generated by a deviation in synchronism between the response time of the liquid crystal and the back light blinking resulting from a change in the response characteristic of the liquid crystal panel 102 due to a change in the panel temperature exceeds an acceptable level which has been decided beforehand. The threshold value varies with the panel temperature. For example, the threshold value for the amount of change of the panel temperature in the range of 10 to 30 degrees C. is set to be ±5 degrees C., and the threshold value for the amount of change of the panel temperature in the range of 30 to 60 degrees C. is set to be ±10 degrees C. A table, in which panel temperatures and threshold values corresponding thereto are associated with each other, has been beforehand prepared by measurements, and held in the ROM.

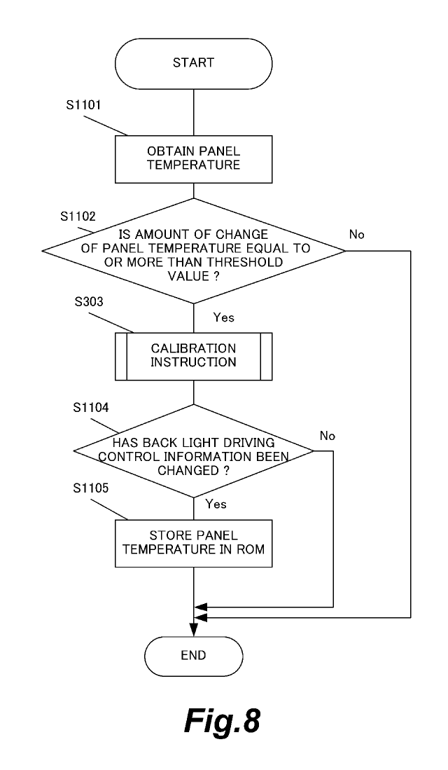

Next, reference will be made to the operation of the display control device 901 by the use of a flow chart shown in FIG. 8. When a user performs a power turn-on operation of the image display apparatus, the processing of this flow chart by means of the CPU 201 is started.

The measurement control unit 1009 obtains the present panel temperature based on the panel temperature information inputted from the panel temperature measuring unit 1005, and outputs it to the calibration instruction unit 1008 (step S1101). The calibration instruction unit 1008 makes a comparison between the panel temperature in the last calibration stored in the ROM and the present panel temperature, and determines whether the amount of change of the panel temperature has exceeded the threshold value (step S1102).

In cases where the amount of change of the panel temperature has not exceeded the threshold value, the processing of this flow chart is ended. On the other hand, in cases where the amount of change of the panel temperature has exceeded the threshold value, the calibration instruction unit 1008 gives an instruction to calibrate the turn on timing of the back light to the response time determination unit 210 (step S303). According to the calibration instruction by the calibration instruction unit 1008, the response time determination unit 210 determines the present response time of the liquid crystal panel 102, similar to the first embodiment (see FIG. 4), and calibrates the turn on timing of the back light according to the present response time of the liquid crystal panel thus determined (see FIG. 3).

The back light setting unit 211 determines whether the back light driving control information has been changed by the calibration (that is, the processing in step S404 has been carried out) (step S1104). In cases where the back light driving control information has not been changed by the calibration, the processing of this flow chart is ended. On the other hand, in cases where the back light driving control information has been changed by the calibration, the response time determination unit saves or stores the present panel temperature in the ROM (step S1105).

Here, note that the threshold value (referred to as C) for the amount of change of the panel temperature used in the determination in step S1102 maybe set to be an amount of change of the panel temperature at which an amount of change of the response time due to the change in temperature of the liquid crystal panel 102 exceeds a threshold value (referred to as B) for the amount of change of the response time which is used in the determination in step S402 of the first embodiment. In this case, at a point in time at which the amount of change of the panel temperature has exceeded the threshold value C in step S1102, a determination can be made that the amount of change of the response time of the liquid crystal panel 102 has exceeded the threshold value B, and hence, in the flowchart of FIG. 3, the determination processing of step S402 may be omitted. In other words, in this case, when it is determined that the amount of change of the panel temperature has exceeded the threshold value C, calibration is always carried out.

As described above, in cases where it is determined from the change in temperature of the liquid crystal panel display 102 that the response time of the liquid crystal panel has a change exceeding the threshold value thereof, the response time determination unit 210 changes or modifies the back light driving control information in accordance with the present response characteristic of the liquid crystal panel. As a result of this, even in cases where the response characteristic of the liquid crystal panel has changed due to a change in temperature thereof, it is possible to make the turn off period of time by the back light blinking in synchronization with the response time of the liquid crystal panel with a high degree of accuracy, so it becomes possible to reduce the blurring of moving images in a suitable manner, irrespective of the temperature of the liquid crystal panel.

Note that the determination of the response time in step S401 may be carried out based on the result of measurement by the panel front face luminance measuring unit 103, similar to the first embodiment. Alternatively, the response time of the liquid crystal panel 102 corresponding to the present temperature of the liquid crystal panel 102 may be determined with reference to a response time estimation table which has been stored in the ROM. Here, the response time estimation table is a table in which the panel temperature is associated with the response characteristic (response time, liquid crystal rise start time, liquid crystal rise end time, etc.) of the liquid crystal panel. Such a table has been beforehand prepared by measurements, etc., and held in the ROM.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-042159, filed on Feb. 28, 2011, and Japanese Patent Application No. 2011-281930, filed on Dec. 22, 2011, which are hereby incorporated by reference herein in their entirety.

What is claimed is:

1. An image display apparatus comprising:
a back light;
a display panel that displays an image based on image data which is inputted thereto, by changing a transmissivity of light from said back light in accordance with said inputted image data;
an obtaining unit for obtaining a response start timing and a response end timing of said display panel in the case of said inputted image data having changed; and
a control unit for carrying out control to turn on and off said back light based on the response start timing and the response end timing of said display panel obtained by said obtaining unit, in cases where said inputted image data has changed;
wherein said control unit changes the timing of turning on and off of said back light in accordance with a response time which is an interval of time from the response start timing of said display panel to the response end timing thereof.

2. The image display apparatus as set forth in claim 1, wherein said control unit changes the timing of turning on and off of said back light, in cases where a difference between a present response time of said display panel obtained by said obtaining unit and a response time of said display panel obtained by said obtaining unit in a change of the timing of turning on and off of said back light made at the last time exceeds a threshold value.

3. The image display apparatus as set forth in claim 1, further comprising:
a measurement unit for measuring a time elapsed after said display panel starts to display an image;
wherein said control unit changes the timing of turning on and off of said back light each time the elapsed time measured by said measurement unit increases by a predetermined period of time.

4. The image display apparatus as set forth in claim 1, further comprising:
a calculation unit for calculating an accumulated display period of time which is a value obtained by integrating periods of time in which said display panel displayed images, from a point in time at which said display panel displayed an image for the first time;
wherein said control unit changes the timing of turning on and off of said back light each time the accumulated display period of time calculated by said calculation unit reaches one of a plurality of threshold values which are set in a stepwise manner.

5. The image display apparatus as set forth in claim 1, further comprising:
a temperature measuring unit for measuring a temperature of said display panel;
said control unit changes the timing of turning on and off of said back light, in cases where a difference between a present temperature of said display panel measured by said temperature measuring unit and a temperature of said display panel measured by said temperature measuring unit in a change of the timing of turning on and off of said back light made at the last time exceeds a threshold value.

6. The image display apparatus as set forth in claim 1, further comprising:
a luminance measuring unit for measuring a luminance of a predetermined area to be measured of said display panel;
wherein said obtaining unit obtains the response start timing and the response end timing of said display panel based on a change in the luminance value of said area to be measured which is measured by said luminance measuring unit, in cases where image data is inputted in which an image displayed on the area to be measured is changed over from a black image to a white image in a state where said back light has been caused to always turn on.

7. The image display apparatus as set forth in claim 1, further comprising:
a calculation unit for calculating an accumulated display period of time which is a value obtained by integrating periods of time in which said display panel displayed images, from a point in time at which said display panel displayed an image for the first time; and
a storage unit for storing a table in which the accumulated display period of time is associated with the response start timing and the response end timing of said display panel;
wherein with reference to the table stored in said storage unit, said obtaining unit obtains the response start timing and the response end timing of said display panel from the accumulated display period of time calculated by said calculation unit.

8. The image display apparatus as set forth in claim 1, further comprising:
a temperature measuring unit for measuring a temperature of said display panel; and
a storage unit for storing a table in which the temperature of said display panel is associated with the response start timing and the response end timing of said display panel;
wherein with reference to the table stored in said storage unit, said obtaining unit obtains the response start timing and the response end timing of said display panel from the temperature of said display panel measured by said temperature measuring unit.

9. The image display apparatus as set forth in claim 1, wherein said display panel is a liquid crystal panel.

10. A control method for an image display apparatus which has aback light, and a display panel that displays an image based on image data which is inputted thereto, by changing a transmissivity of light from said back light in accordance with said inputted image data, said method comprising:
an obtaining step of obtaining a response start timing and a response end timing of said display panel in the case of said inputted image data having changed; and
a control step of carrying out control to turn on and off said back light based on the response start timing and the response end timing of said display panel obtained in said obtaining step, in cases where said inputted image data has changed;
wherein in said control step, the timing of turning on and off of said back light is changed in accordance with a response time which is an interval of time from the response start timing of said display panel to the response end timing thereof.
